(19) United States
(12) Patent Application Publication
(10) Pub. No.: US 2005/0270462 A1
(43) Pub. Date: Dec. 8, 2005

(54) Liquid crystal display device

(76) Inventor: Norio Koma, Motosu-gun (JP)

Correspondence Address: CANTOR COLBURN, LLP, 55 GRIFFIN ROAD SOUTH, BLOOMFIELD, CT, 06002, US

(21) Appl. No.: 11/132,796

(22) Filed: May 19, 2005

(30) Foreign Application Priority Data
May 21, 2004 (JP) 2004-152610

(51) Int. Cl. G02F 1/1337

(52) U.S. Cl. 349/129

(57) ABSTRACT

A liquid crystal display device is configured by sealing a liquid crystal layer between a first substrate including a first electrode and a second substrate including a second electrode. Each pixel region includes an alignment controller for dividing liquid crystal alignment within one pixel into multiple sections having different alignment directions. The alignment controller at least includes a region in which an electrode absent portion and a protrusion including a slant surface protruding toward the liquid crystal layer are formed at the same location in an overlapping manner on at least one of the first substrate or the second substrate side. Using both the liquid crystal alignment control effected by an adjustable electric field generated at the electrode absent portion and the alignment control effected by the slant surface of the protrusion, alignment division of the liquid crystal can be reliably performed within a small area.

### CROSS-REFERENCE TO RELATED APPLICATIONS

The priority Japanese application No. 2004-152610, upon which this patent application is based, is hereby incorporated by reference.

### BACKGROUND OF THE INVENTION

1. Field of the Invention

The present invention relates to a liquid crystal display device including an alignment controller for dividing one pixel region into sections having different directions of liquid crystal alignment.

2. Description of the Related Art

Liquid crystal display devices (hereinafter referred to as LCDs) have advantageous features such as thin structure and low power consumption, and are now widely employed as computer monitors and display panels for portable information devices. Such an LCD is formed by sealing liquid crystal between a pair of substrates. An indication on the LCD is achieved by controlling alignment of the interposed liquid crystal by means of electrodes formed on the respective substrates.

Use of TN (twisted nematic) liquid crystal as the liquid crystal for the LCD is known. In an LCD which employs TN liquid crystal, an alignment film which has been subjected to a rubbing treatment is provided on each of the pair of substrates on the side which contacts the liquid crystal. When no voltage is applied, the TN liquid crystal which has positive dielectric constant anisotropy is initially aligned such that the long axes (major axes) of the liquid crystal molecules are positioned along the rubbing direction of the alignment films. Typically, the initial alignment of the liquid crystal is not completely parallel to the substrate plane but is such that the long axes of the molecules are positioned at a predetermined angle with respect to the substrate plane, namely, with a pretilt.

The alignment films on the respective substrates are arranged such that the rubbing direction of the alignment film on one of the substrate is twisted by 90° with respect to the rubbing direction of the alignment film on the other substrate. Accordingly, the liquid crystal between the pair of substrates is oriented with a twist by 90°. When a voltage is applied to the interposed liquid crystal by means of the electrodes formed on the opposed sides of the pair of substrates, the long axes of the crystal molecules are placed in an upright position along a normal line to the substrate plane, such that the twisted alignment state is removed.

The pair of substrates are provided with linear polarization plates, respectively, which have polarization axes that are orthogonal to one another. Further, the rubbing direction of each alignment film is arranged along the polarization axis of the polarization plate on the corresponding substrate. Accordingly, in a state of no voltage application, linearly polarized light which is introduced into the liquid crystal layer via the polarization plate provided on the substrate on the light source side is changed by the liquid crystal layer arranged in the 90° twisted alignment state, such that the resulting light is linearly polarized light having the axis of polarization shifted by 90°. This light is transmitted via the polarized plate provided on the other substrate, which only permits transmission of linearly polarized light having the axis of polarization shifted by 90° from that of the introduced light transmitted via the polarization plate on the incident side. As such, light from the light source is transmitted through the LCD, thereby achieving indication of “white”. In contrast, when a voltage is applied between the electrodes such that the twisted alignment state of the liquid crystal is completely removed and the liquid crystal molecules are aligned along the normal direction to the substrate plane, linearly polarized light which is introduced into the liquid crystal layer from the light source side reaches the polarization plate provided on the other substrate side without being changed by the liquid crystal layer. Accordingly, the axis of this linearly polarized light does not match the polarization axis of the polarization plate on the emitting side. As a result, the linearly polarized light cannot pass through the polarization plate on the emitting side. In this manner, “black” indication is achieved. Halftone indications are accomplished by applying a voltage to the liquid crystal in a manner such that the twisted alignment of the liquid crystal layer is not completely removed. By applying such a voltage, the linearly polarized light introduced into the liquid crystal layer is changed into another polarization state which includes linearly polarized light having the axis of polarization shifted by 90° for passage through the polarization plate on the emitting side, thereby attaining adjustment of the amount of transmitted light.

In place of the above-described TN liquid crystal, vertically aligned type liquid crystal (hereinafter referred to as VA liquid crystal) may be used in an LCD. The VA liquid crystal may have negative dielectric constant anisotropy. By employing vertical alignment films, the long axes of the VA liquid crystal molecules are aligned along the vertical direction (normal direction to the substrate plane) when no voltage is applied. In an LCD using the VA liquid crystal, a pair of substrates are provided with polarization plates, respectively, which have polarization axes that are shifted with respect to one another by 90°. In a state of no voltage application, linearly polarized light which is introduced into the liquid crystal layer via the polarization plate provided on the substrate on the light source side reaches the polarization plate provided on the substrate on the viewing side while remaining in the original polarization state and without being subjected to birefringence by the liquid crystal layer, because the liquid crystal is vertically aligned. Accordingly, the light cannot pass through the polarization plate on the viewing side, resulting in “black” indication. When a voltage is applied between the electrodes, the VA liquid crystal is aligned such that the long axes of the molecules are tilted down toward the substrate plane direction. The VA liquid crystal has negative optical anisotropy (refractive index anisotropy), and at this point, the short axes of the liquid crystal molecules are aligned along the normal direction to the substrate plane. The linearly polarized light introduced into the liquid crystal layer from the light source side is therefore subjected to birefringence by the liquid crystal layer. As the linearly polarized light proceeds through the liquid crystal layer, the light is changed into elliptically polarized light, subsequently into circularly polarized light, and finally into elliptically or linearly polarized light (the resulting light in either of the polarized states has the axis component of polarization which is changed by 90° from that of the incident linearly polarized light). When the incident linearly polarized light is entirely changed by birefringence of the liquid crystal layer into linearly polarized light having the axis of polarization shifted by 90°, the resulting light completely transmits through the polarization plate on the viewing side substrate to indicate “white” at maximum brightness. The amount of birefringence is determined by the manner in which the liquid crystal molecules are tilted. Depending on the amount of birefringence, the incident linearly polarized light is changed into any one of elliptically and circularly polarized light having the axis component of polarization identical to that of the incident light or elliptically polarized light having the axis component of polarization shifted by 90°. The polarization state of the resulting light determines the transmittance ratio obtained at the polarization plate on the emitting side. By controlling the amount of birefringence, indication of halftones can be achieved.

As can be understood from the above, in an LCD employing the TN liquid crystal, control is performed by adjusting the degree to which the long axes of the liquid crystal molecules are lifted toward the upright position from the position of the pretilt angle with respect to the substrate plane direction. As shown in FIG. 1A, in a TN-LCD, the tilt of the liquid crystal molecules as observed from the upper right direction in the drawing differs greatly from the tilt as observed from the upper left direction. For this reason, the TN liquid crystal is characterized by high dependence on the viewing angle, such that colors and indications may likely appear reversed. In other words, as is known, the viewing angle at which indications can be seen in the normal state is rather narrow in a TN-LCD.

In order to enlarge the viewing angle, a technique of providing separate liquid crystal alignment directions (azimuth) within one pixel has been proposed in a number of references. For example, Japanese Patent Laid-Open Publication No. Hei 7-311383 describes providing alignment divider within one pixel, and dividing the region of one pixel into discrete sections in which the long axes of the liquid crystal molecules (the liquid crystal director) are oriented in different directions.

In a VA-LCD, as shown in FIG. 1B, the initial alignment of the liquid crystal is along the normal direction with respect to the substrate 100. Accordingly, in FIG. 1B, the difference between the tilt angle of the liquid crystal molecules as observed from the upper right direction and the tilt angle as observed from the upper left direction is small. As such, compared with the above-described TN liquid crystal, the VA liquid crystal is less dependent on the viewing angle in principle. In other words, the VA-LCD has a wider viewing angle. However, the VA liquid crystal is disadvantageous in that the direction (alignment vector) toward which the liquid crystal molecules are tilted from the upright position upon voltage application cannot be uniformly controlled, such that the boundary (disclination line) between sections having different alignment directions within one pixel region cannot be fixedly located at a predetermined position. When the position of the disclination line is different in the respective pixels or is varied in one pixel over a duration of time, roughness may result in an indication, leading to degradation of display quality.

In light of the above disadvantages, references such as Japanese Patent Laid-Open Publication No. Hei 7-311383 describe providing, similarly for VA liquid crystal, alignment divider within one pixel to fix the disclination line at the alignment dividing portion, in order to further enlarge the viewing angle and to enhance display quality.

In FIG. 2, an example VA-LCD is shown to illustrate the manner in which alignment division is effected by means of a protrusion and an electrode absent portion which are provided as conventional alignment divider.

First electrodes (such as pixel electrodes) 200 are formed on a first substrate 100, and an alignment film 260 is formed covering the first electrodes 200. Further, a second electrode (such as a common electrode) 320 is provided on a second substrate 300 arranged opposing the first substrate 100. On the second electrode 320, a protrusion 560 is formed protruding toward a liquid crystal layer 400. An alignment film 260 similar to the alignment film on the first substrate side is deposited over the entire surface of the second substrate 300 covering the protrusion 560 and the second electrode 320. With this arrangement, a slant surface shaped in accordance with the slope of the underlying protrusion 560 is created in the liquid-crystal-contacting side of the alignment film 260 on the second substrate 300. When this alignment film 260 is a vertical alignment film, the liquid crystal director 410 is controlled in vertical alignment with respect to the slant surface of this alignment film. Accordingly, the protrusion 560 serves to mark the boundary at which the alignment directions (alignment vectors) of the liquid crystal directors 410 are separated into those for the right and left sections in FIG. 2. Further, a space between two adjacent first electrodes 200 formed on the first substrate 100 serves as an electrode absent portion 530. At the electrode absent portion 530, when a voltage is applied to the opposing first electrode 200 and second electrode 320, a tilted weak electric field is generated as shown by dashed lines in FIG. 2. The short axes (minor axes) of the liquid crystal molecules having negative dielectric constant anisotropy align along the normal direction to the electric field lines (dashed lines) of this electric field. In this manner, the electrode absent portion 530 also serves to mark the boundary at which the alignment directions of the liquid crystal directors 410 are separated.

As described above, using the protrusion 560 and the electrode absent portion 530, it is possible to provide within one pixel region a plurality of sections having alignment directions (alignment vectors) which differ from one another. In order to enhance the liquid crystal dividing ability of the protrusion 560 and the electrode absent portion 530, increase in the sizes of these components are required. Specifically, in the case of the protrusion 560, the height of the protrusion 560 must be increased by providing a larger slant surface area and a larger slant angle. Concerning the electrode absent portion 530, it is necessary to increase the space (distance) in which the first electrode is not formed.

However, at the portions where the protrusion 560 and the electrode absent portion 530 are formed, the transmittance ratio becomes reduced because, in the case of the above-describe VA liquid crystal, the alignment direction of the liquid crystal is not easily changed at these portion when the voltage is applied. Further, because the liquid crystal alignment direction at the slant surface of the protrusion 560 becomes slightly tilted from the perpendicular direction to the substrate plane, in a normally black mode, light is undesirably transmitted in this region where the slant surface is formed. Accordingly, if the protrusion 560 is made larger, the contrast ratio given by (luminance during white indication/luminance during black indication) becomes reduced. As such, attempts to increase the height of the protrusion 560 and the width of the electrode absent portion 530 in order to enhance the alignment dividing ability would disadvantageously result in reducing the display region and degrading the transmittance or reflectance ratio and the contrast ratio of the LCD.

Furthermore, in order to produce a high-definition LCD, the distance between pixel regions must be minimized. For this reason the extent to which the width of the electrode absent portions 530 between the pixels can be increased is rather limited.

### SUMMARY OF THE INVENTION

The present invention provides an LCD having a wide viewing angle, high transmittance or reflectance ratio, and high contrast.

An LCD according to the present invention which realizes the above-listed features is configured by providing a first substrate including a first electrode and a second substrate including a second electrode in an opposed arrangement with respect to one another, and interposing a liquid crystal layer between those substrates. Each pixel region includes an alignment controller for dividing liquid crystal alignment within one pixel region into a plurality of sections having different alignment directions. The alignment controller includes at least a region in which an electrode absent portion and a protrusion are formed at the same location in an overlapping manner on at least one of the first substrate side or the second substrate side. The protrusion includes a slant surface which protrudes toward the liquid crystal layer.

At the electrode absent portion, an electric field which is tited with respect to a normal direction to the substrate plane is generated, and directions of liquid crystal alignment are thereby divided at the electrode absent portion which marks the boundary. At the protrusion, initial alignment of the liquid crystal is controlled with respect to the plane of the slant surface, and directions of liquid crystal alignment are thereby divided at the protrusion which marks the boundary.

By forming the electrode absent portion and the protrusion at the same location in an overlapping manner according to the present invention, sufficient alignment dividing control can be attained by the joint effect of those components even when the width of the electrode absent portion is made narrow and the width and height of the protrusion are reduced. Specifically, when the width of the electrode absent portion is narrow, the tilt of the electric field generated at an edge of the electrode absent portion becomes small. However, in the same location, the slant surface of the protrusion exerts an attractive force for aligning liquid crystal with respect to the slant surface. Accordingly, even though the tilt of the electric field may be small, the directions of liquid crystal alignment can be clearly divided at the position of the alignment controller. Stating from the opposite aspect, when the height and width of the protrusion are reduced, namely, when the size of the protrusion is small, only a small difference is created between the alignment angle of the liquid crystal controlled by the slant surface of the protrusion and the alignment angles in other regions. In addition, the area controlled by the protrusion becomes smaller. However, because the force for controlling liquid crystal alignment produced by the tilted electric field generated at the electrode absent portion is additionally exerted at this location, reliable alignment dividing control can be achieved. With this arrangement, high contrast, wide viewing angle, and high transmittance or reflectance ratio can be attained while reducing the area of the alignment controller.

According to another aspect of the present invention, the liquid crystal in the above-described LCD may be TN liquid crystal, or alternatively, VA liquid crystal in which the initial alignment of the liquid crystal layer becomes oriented along a vertical direction to the substrate plane.

Using liquid crystal of either mode, reliable alignment division, high contrast, and high transmittance or reflectance ratio can be realized by forming the electrode absent portion and the protrusion at the same location in an overlapping manner so as to provide an alignment controller within one pixel region.

According to a further aspect of the present invention, in the above-described LCD, as an alignment controller within one pixel region, one or both of an electrode absent portion and a protrusion may further be formed on the same or different substrate side as the first or second substrate side on which the overlapped structure composed of the electrode absent portion and the protrusion is provided.

In addition to the alignment control effected by means of an overlapped structure composed of an electrode absent portion and a protrusion, alignment control can also be executed using only one of an electrode absent portion or a protrusion depending on locations. With this arrangement, reliable alignment dividing control can be performed while taking into account limitations and requirements related to designing and fabrication, such as matters concerning pixel layout.

According to a still further aspect of the present invention, in the above-described LCD, the first electrode provided on the first substrate side is formed in individual patterns for the respective pixels. In other words, a multiple number of first electrodes are formed on the first substrate side as pixel electrodes. A switch element is connected to each of the plurality of first electrodes. The second electrode provided on the second substrate side is formed as a common electrode which serves commonly for the respective pixels. The alignment controller is formed within a forming region of the pixel electrode or within one pixel region of the common electrode.

According to another aspect of the present invention, in the above-described LCD, the first electrode provided on the first substrate side is formed in individual patterns for the respective pixels. In other words, a multiple number of first electrodes are formed on the first substrate side as pixel electrodes. A switch element is connected to each of the plurality of first electrodes. The second electrode provided on the second substrate side is formed as a common electrode which serves commonly for the respective pixels. The pixel electrodes are arranged on the first substrate side in a matrix pattern. The LCD further comprises, between adjacent pixel electrodes, an alignment controller composed by forming an electrode absent portion and a protrusion in an overlapping arrangement, or an alignment controller composed of an electrode absent portion alone.

The above-described LCD may be employed as a reflective type LCD, in which a reflective layer for reflecting light incident from the viewing side is provided on one of the first or second substrate side which is arranged opposite the viewing side substrate.

The above-described LCD may also be employed as a transmissive type LCD, in which the first and second electrodes are transparent electrodes, and indication is achieved by transmitting light from the light source which is provided on the rear side of one of the first or second substrate arranged away from the viewing side.

Moreover, the above-described LCD may also be employed as a semi-transmissive LCD. In a semi-transmissive LCD, one pixel region comprises a reflective region in which external light is reflected and a transmissive region in which light from the light source is transmitted. By providing both the reflective region and the transmissive region, an indication having high contrast and wide viewing angle can be obtained in the presence of strong external light (such as outdoors) as well as in a dark environment. Further, by providing the above-described alignment controller in each of the reflective region and the transmissive region, display quality enhancements in both display modes, namely, the reflective and transmissive modes, can be attained.

As described above, the present invention prevents generation of disclination lines, enlarges the viewing angle, and attains high contrast, high transmittance or reflectance ratio, and enhanced alignment control in an LCD.

### BRIEF DESCRIPTION OF THE DRAWINGS

Preferred embodiments of the present invention will be described in detail based on the following figures, wherein:

FIGS. 1A and 1B are diagrams for explaining the difference in viewing angle between TN liquid crystal and VA liquid crystal;

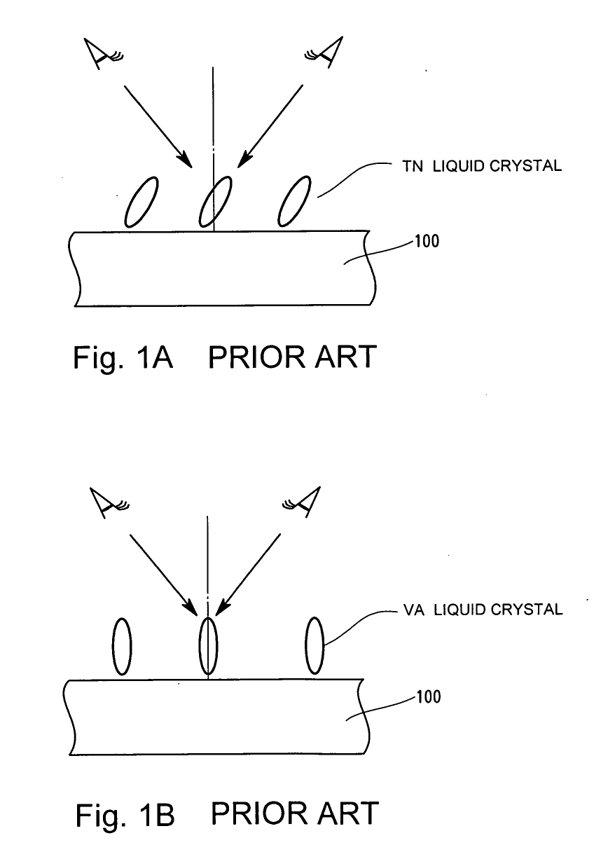

FIG. 2 is a diagram illustrating the manner in which alignment division is effected by means of a conventional alignment controller;

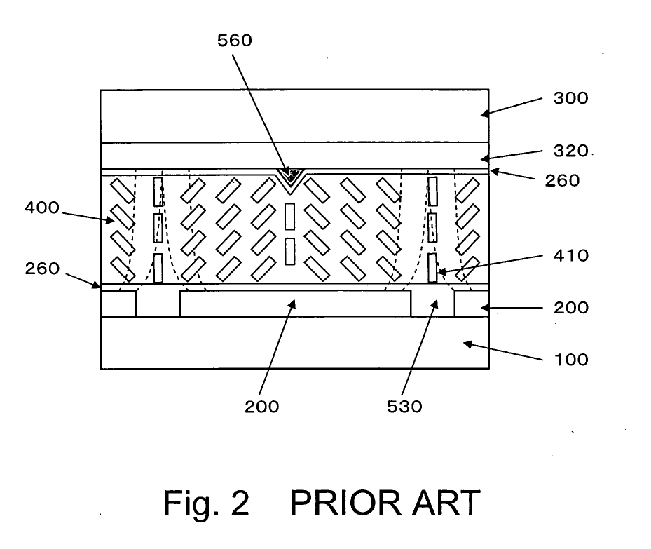

FIG. 3 is a schematic cross-sectional view showing a structure of an LCD according to an embodiment of the present invention;

FIGS. 4A, 4B, and 4C are diagrams showing example patterns of the alignment controllers according to an embodiment of the present invention;

FIG. 5 is a schematic cross-sectional view showing a structure of an LCD according to an embodiment of the present invention;

FIG. 6 is a schematic plan view showing a semi-transmissive LCD according to an embodiment of the present invention;

FIG. 7 is a cross-sectional structural view taken along line A-A′ in FIG. 6; and

FIG. 8 is a schematic cross-sectional view showing a structure of a pixel portion of an active matrix type LCD according to an embodiment of the present invention.

### DESCRIPTION OF THE PREFERRED EMBODIMENTS

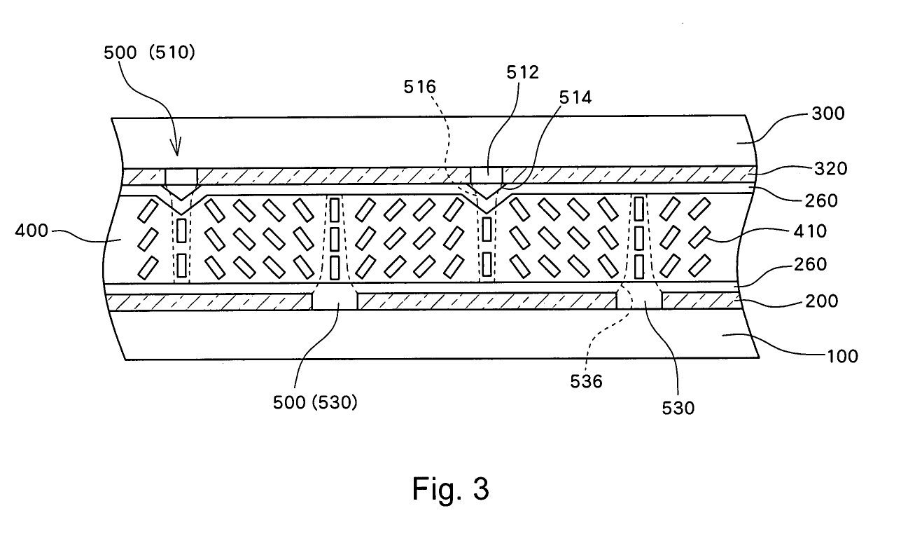

FIG. 3 is a schematic cross-sectional view showing a structure of an LCD according to an embodiment of the present invention. In the example shown in FIG. 3, the LCD is a transmissive type LCD in which light from a light source is transmitted. A liquid crystal layer 400 is sealed between a first substrate 100 and second substrate 300 which are both transparent substrates. A first electrode 200 and a second electrode 320, each composed of a transparent conductive material such as ITO (indium tin oxide) and IZO (indium zinc oxide), are formed on the respective substrates 100, 300 on the side facing the liquid crystal layer 400.

As the liquid crystal layer 400, vertically aligned liquid crystal having negative dielectric constant anisotropy is employed in this example. Alignment controllers (alignment divider) 500 for dividing one pixel region into a plurality of alignment regions are provided on both the second substrate 300 side and the first substrate 100 side. The alignment controller 500 provided on the first substrate 100 side is configured as an electrode absent portion 530, which is formed by a gap in the first electrode 200. An alignment film 260 composed of polyimide or the like is formed over the entire surface of the first substrate 100 covering the electrode absent portions 530 and the first electrode 200.

On the second substrate 300 side, an electrode absent portion 512 is created in the second electrode 320, and a protrusion 514 which protrudes toward the liquid crystal layer 400 is formed over the electrode absent portion 512. An alignment film 260 similar to that provided on the first substrate 100 side is formed over the entire surface covering the protrusion 514 (which is arranged over the electrode absent portion 512) and the second electrode 320. Both alignment films 260 formed on the first and second substrates are vertical alignment films, which may be of a rubbingless type.

In the above-described configuration, at the alignment controller 510 on the second substrate 300 side, when no voltage is applied between the first electrode 200 and the second electrode 320, the liquid crystal director 410 is perpendicularly aligned with respect to the slant surface of the alignment film 260 formed along the slant surface of the protrusion 514 having a triangular cross-section.

When a voltage is applied between the first electrode 200 and the second electrode 320 to thereby generate a weak electric field between the two electrodes, at the edges of the electrode absent portion 512 (namely, edges of the second electrode 320) located underlying the protrusion 514, the electric field lines shown by dashed lines in FIG. 3 are tilted in a tilted angle such that the lines spread from the edges of the electrode 320 toward the center of the electrode absent portion 512. The short axes (minor axes) of the liquid crystal having negative dielectric constant anisotropy align along these tilted electric field lines. In accordance with an increase of the voltage applied to the liquid crystal, the tilt of the electric field which is adjusted by the applied voltage determines the direction of tilt of the liquid crystal molecules from the initially aligned state. Accordingly, with the alignment controller 510 marking the boundary, a region of the liquid crystal is divided into alignment regions having at least different directions (azimuths) from one another.

Likewise, at the electrode absent portion 530 formed by the gap in the first electrode on the first substrate side, the alignment directions of the liquid crystal are controlled by a similar tilted electric field. The electrode absent portion 530 marks the boundary at which alignment of the liquid crystal is divided into different directions.

As such, using the alignment controller 510 and the electrode absent portion 530, alignment division can be achieved at formation regions of those components. However, it should be noted that, as shown in FIG. 3, the width of the electrode absent portion 512 in the alignment controller 510 configured by overlapping the electrode absent portion 512 and the protrusion 514 can be made narrower compared to the width of the electrode absent portion 530 in the alignment controller 500 configured using only the electrode absent portion. In other words, by forming the electrode absent portion 512 and the protrusion 514 at the same location in an overlapping manner, sufficient alignment dividing control can be attained even if the width of the electrode absent portion is made narrow because an additional effect of alignment dividing control is provided by the protrusion.

To explain in detail, when the width of the electrode absent portion 512 is made narrower than that of the electrode absent portion 530, the tilted angle of the electric field (electric field lines) 516 generated at the edges of the electrode absent portion 512 becomes smaller than that of the electric field (electric field lines) 536 generated at the edges of the electrode absent portion 530. When the tilted angle is smaller, the liquid crystal molecules which align along the orthogonal direction to the electric field lines 516 tilt at a smaller angle with respect to the normal line to the substrate plane, resulting in a smaller difference between the alignment of the liquid crystal molecules in this region around the alignment controller and the vertically aligned liquid crystal molecules in other regions. In other words, the alignment dividing ability of the less tilted electric field is lowered. However, the protrusion 514 is formed at the location where the less tilted electric field is generated. The protrusion 514 is configured with a slant surface which slopes into the liquid crystal layer from the edges of the electrode absent portion 512 toward its center, similarly to the tilt of the electric field lines 516 generated by the electrode absent portion 512. Because the vertical alignment film 260 is employed in this example, an attractive force is exerted on the liquid crystal director 410 for aligning along directions orthogonal to the slant surface of the protrusion 514. In this manner, alignment directions of the liquid crystal can be reliably separated at the alignment controller 510 despite the small tilt of the electric field 516.

Further, as noted above, when the height and width of the protrusion 514 are reduced, namely, when the size of the protrusion 514 is made small, the angle of the slant surface of the protrusion with respect to the substrate plane becomes smaller. As a result, the aligned angle of the liquid crystal in the formation region of the alignment controller 510 differs by only a small extent from the aligned angle in other regions in which the liquid crystal is aligned along the normal direction to the substrate plane. Accordingly, the ability to control liquid crystal alignment becomes lowered if only the small protrusion 514 is provided. However, because the force for controlling liquid crystal alignment produced by the tilted electric field 516 generated at the electrode absent portion 512 is additionally exerted at this location, alignment division can be reliably performed. When the alignment controller 510 is configured by arranging the protrusion 514 and the electrode absent portion 512 in an overlapping manner as described above, reliable alignment division can be achieved using the small protrusion 514 and the narrow electrode absent portion 512. According to the present embodiment in which the width of the electrode absent portion 512 can be reduced, an improvement in pixel transmittance or reflectance ratio can be attained corresponding to width reduction. Further, because the width (corresponding to the base of the triangular cross-section) and the height of the protrusion 514 can be reduced, degradation of contrast can be avoided.

In the example shown in FIG. 3, the width of the protrusion 514 is made slightly larger than the width of the electrode absent portion 512, such that the protrusion 514 completely covers the edges of the electrode absent portion 512. However, this size relationship is not a requirement according to the present invention. The widths of the protrusion 514 and the electrode absent portion 512 may be identical, or, in contrast to the above example, the width of the protrusion 514 may be made smaller than the width of the electrode absent portion 512. It is preferable that the two components are designed to have approximately the same and narrow widths. It should be noted that an unnecessary slant in the liquid crystal contacting surface may cause an alignment disorder. In order to avoid the occurrence of such a disorder, when the protrusion 514 is provided in an overlapping arrangement with the electrode absent portion 512, the protrusion 514 is preferably designed to have a width which is just enough to completely extend over the width of the electrode absent portion 512.

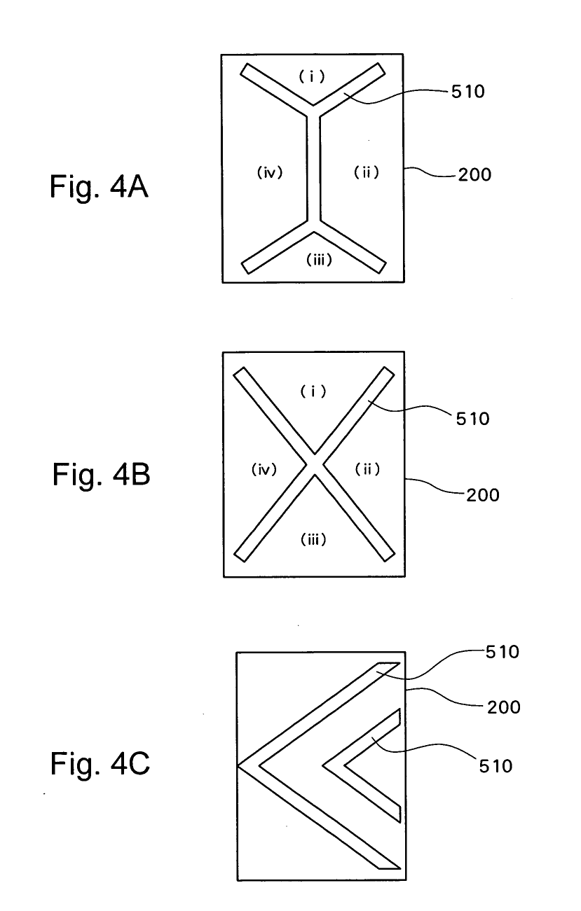

Next, example patterns of the alignment controller 510 configured as an overlapped structure composed of the electrode absent portion 512 and the protrusion 514 shown in FIG. 3 are described referring to FIGS. 4A-4C. In the following description, it is assumed that each pixel region of the LCD is defined by the shape of the first electrode 200. As shown in FIG. 4A, one pattern of the alignment controller 510 comprises a central line which extends along the vertical scan direction (vertical direction in the drawing) in a central portion within one pixel region (200) so as to divide the region into left and right sections (along the horizontal scan direction), and lines which extend from the respective four corners of the pixel toward the upper or lower ends of the central line. In other words, this pattern has a shape obtained by connecting a Y shape to an inverted Y shape. By employing an alignment controller 510 shaped in this pattern, it is possible to divide one pixel region into four (upper, lower, left, and right) sections having different alignment directions.

Alternatively, the alignment controller 510 may be shaped in a substantially X pattern which extends along the two diagonals of the rectangular pixel region (200) as shown in FIG. 4B. With this arrangement, one pixel region can be divided into four (upper, lower, left, and right) sections having different alignment directions, similarly to the pattern of FIG. 4A.

Furthermore, the alignment controller 510 may be formed in multiple patterns each substantially having a shape of an inequality symbol (comprising two oblique line segments forming an angle) within one pixel region, as shown in FIG. 4C. With this arrangement, one pixel region can be divided into a plurality of sections having different alignment directions.

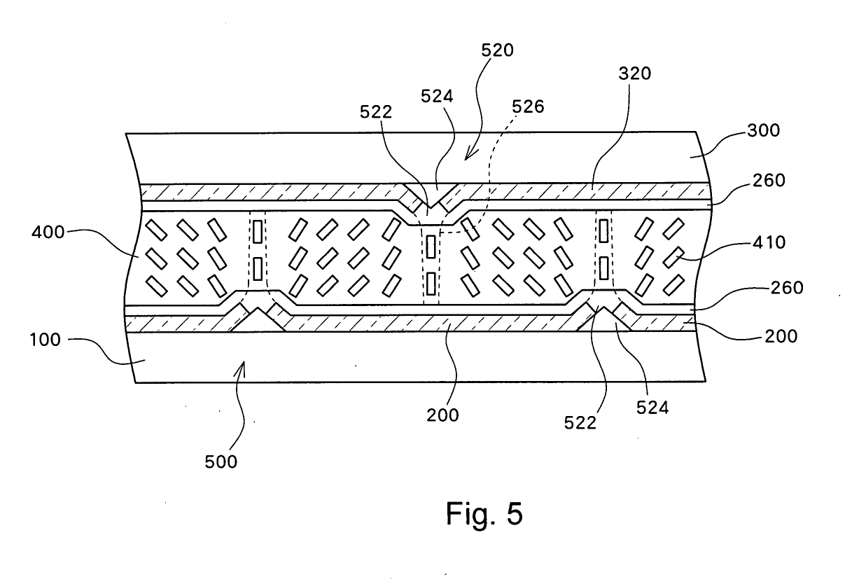

FIG. 5 shows an embodiment of the present invention which differs from that shown in FIG. 3. FIG. 5 is identical to FIG. 3 in that the alignment controller 500 is configured by forming the electrode absent portion and the protrusion at the same location in an overlapping manner. The difference in the embodiment of FIG. 5 is that the electrode absent portion is formed overlying the protrusion. More specifically, a protrusion 524 having a triangular cross-section which protrudes toward the liquid crystal layer 400 is formed on the second substrate 300, for example, and the second electrode 320 is formed over the protrusion 524. Further, in the vicinity of the peak (apex) of the protrusion 524, an electrode absent portion (window or slit) 522 is provided in the second electrode 320. The portion of the second electrode 320 which is arranged covering the protrusion 524 (excluding the peak region in which the electrode absent portion 522 is formed) defines, on the side which contacts the liquid crystal layer, a slant surface shaped according to the slope of the protrusion 524. The alignment film 260 is formed covering the second electrode 320 and the peak portion of the protrusion 524 which is exposed by the electrode absent portion 522. At the alignment controller 520 formed as described above and shown in FIG. 5, the liquid crystal director 410 is vertically aligned with respect to the slant surface shaped along the protrusion 524, while the liquid crystal alignment is additionally controlled by the tilted electric field 526 generated at the edges of the electrode absent portion 522. As such, similarly to the alignment controller 510 shown in FIG. 3, the configuration of the alignment controller 520 makes it possible to achieve reliable alignment division using the small protrusion 524 and the narrow electrode absent portion 522, thereby making it possible to realize an LCD having high contrast, wide viewing angle, and high transmittance or reflectance ratio.

Further, in the example shown in FIG. 5, the alignment controller 520 is also provided on the first substrate 100 side by forming in an overlapping arrangement a protrusion 524 and an electrode absent portion 522 of the first electrode 200. By forming the alignment controllers 520 each configured as an overlapped structure composed of a protrusion 524 and an electrode absent portion 522 on both the second substrate 300 side and the first substrate 100 side, the distance between pixels can be reduced to the minimum, which would be effective in a high-definition (high-resolution) LCD. The distance between pixels can be similarly minimized to achieve high contrast, wide viewing angle, and high transmittance or reflectance ratio in a high-definition LCD by forming on both the second substrate side and the first substrate side the alignment controllers 510 as shown in FIG. 3, each configured by overlapping a protrusion 514 over an electrode absent portion 512. Similarly to on the first substrate side in FIG. 3, an alignment controller on the first substrate side in FIG. 5 may be formed using an electrode absent portion alone without providing a protrusion.

In FIG. 3, the thickness of the second electrode may be several ten nm (for example, in the range from 10 nm to 50 nm), while the alignment controller 510 may be configured with the width of the electrode absent portion 512 being approximately 3 μm, the height of the protrusion 514 being within the range from 0.5 μm to 2 μm, and the width (at the bottom surface) of the protrusion 514 being within the range from 5 μm to 7 μm. While the sizes are not limited to those listed above, it should be noted that the electrode absent portion according to the present invention can be formed very narrow with a width of 3 μm or the like, whereas a width of approximately 10 μm is typically required for an electrode absent portion when alignment division is effected using only the electrode absent portion. Because indication can be performed at the formation region of the slant surface of the protrusion 514 as long as an electrode is present over or under the slant surface, a reduction in the width of the electrode absent portion at which indication cannot be performed is advantageous in enhancing the transmittance or reflectance ratio of the LCD.

The LCD according to the embodiments of the present invention may be a passive matrix type LCD or an active matrix type LCD. In either type of LCD, high contrast, wide viewing angle, and high transmittance or reflectance ratio can be attained by providing within one pixel region an alignment controller 500 which is configured as an overlapped structure composed of a protrusion and an electrode absent portion, as shown in FIG. 3 or 5.

When the examples shown in FIGS. 3 and 5 illustrate portions of a passive matrix type LCD, stripe patterns of the first electrodes 200 and second electrodes 320 are formed on the first substrate 100 and the second substrate, respectively, along directions which are orthogonal to one another. The region in which the first 200 and second 320 electrodes intersect with the liquid crystal layer interposed therebetween defines one pixel region.

In an active matrix type LCD, a switch element is provided in each pixel. A pixel electrode having an individual pattern for each pixel is connected to this switch element. A common electrode which serves commonly for the respective pixels is provided opposite the pixel electrodes while the liquid crystal layer is interposed between the pixel electrodes and the common electrode. In the examples shown in FIGS. 3 and 5, the first electrode 200 may be regarded as a pixel electrode formed in an individual pattern for each pixel while the second electrode 320 is recognized as the common electrode (as is apparent, conversely, the second electrode 320 may be considered as the individual pixel electrode while the first electrode is regarded as the common electrode) . A schematic structure and manufacturing method of the first electrode 200 (serving as the pixel electrode) and a switch element (configured as a thin film transistor (TFT)) connected thereto in an active matrix type LCD are described later.

While vertically aligned (VA) liquid crystal having negative dielectric constant anisotropy was employed as the example liquid crystal in the above description, the present invention is similarly effective in an LCD which uses TN liquid crystal. Specifically, by forming the above-described alignment controllers 510 or 520 within each pixel region of a TN-LCD, high contrast and high transmittance or reflectance ratio can be attained while drastically enlarging the viewing angle. When using TN liquid crystal, the alignment directions are controlled by the slant surface of the protrusion, such that alignment of the liquid crystal is divided into different directions (alignment orientations) at the protrusion. Further, alignment of the TN liquid crystal remains unchanged from the direction along the substrate plane at the electrode absent portion, while the long axes of the liquid crystal molecules are controlled along the tilt of the weak electric field (electric field lines) generated at the edges of the electrode absent portion. As such, regions having different liquid crystal alignment directions are created with the electrode absent portion marking the boundary.

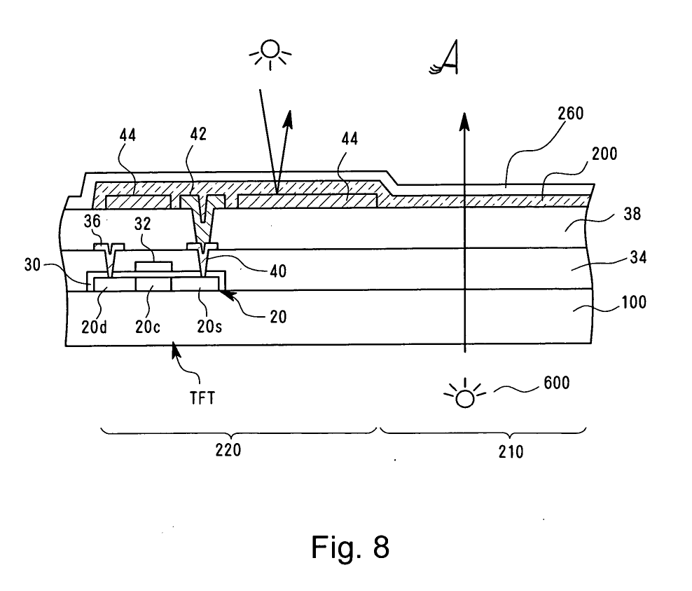

The alignment controllers 510 and 520 according to the above embodiments of the present invention can be employed in a reflective type LCD, a transmissive type LCD, and, as detailed later, in a semi-transmissive LCD. A transmissive type LCD can be obtained by forming the first and second electrodes 200, 320 of FIGS. 3 and 5 as transparent electrodes using materials such as ITO and IZO, and using transparent substrates made of glass or the like as the first and second substrates 100, 300. As shown in FIG. 8 described later, in a transmissive type LCD, light is introduced into the liquid crystal layer 400 from a light source 600 arranged on the first substrate side, for example. The amount of light emitted from the second substrate side is controlled by adjusting a voltage applied to the liquid crystal layer.

A reflective type LCD can be obtained by providing a reflective layer on one of the first and second substrates, so as to allow external light introduced into the liquid crystal layer to be reflected by the reflective layer and passed through the liquid crystal layer again. The amount of light emitted outward from the substrate on the viewing side is controlled in accordance with a voltage applied to the liquid crystal layer. In such a reflective type LCD, the first electrode 200 in FIGS. 3 and 5 (or the pixel electrodes 200 in FIGS. 4A-4C) may be formed using a reflective electrode material such as Al and Ag. Alternatively, a reflective plate may be provided on the underside of the first electrode 200. For example, the reflective plate may be arranged on the rear side surface of the first substrate 100.

A semi-transmissive type LCD can be obtained by providing within one pixel region a reflective region, in which a reflective layer is formed, and a transmissive region. By using the above-described alignment controller 510 or 520 in at least a portion of the reflective region and the transmissive region, a wider viewing angle and high contrast indication can be achieved in both reflective and transmissive display modes. When the semi-transmissive type LCD is of an active matrix type, as shown in FIG. 8 described later, a TFT is formed between the first substrate 100 and the first electrode 200 formed as the pixel electrode on the first substrate side. In order to arrange a transmissive region 210 and a reflective region 220 as efficiently as possible within one pixel region, and particularly for the purpose of preventing degradation of the transmittance ratio in the transmissive region 210, the TFT, which is typically formed in a light-shielded region within a transmissive LCD, is arranged in the reflective region 220 within the semi-transmissive type LCD such that no influence on transmittance ratio is generated.

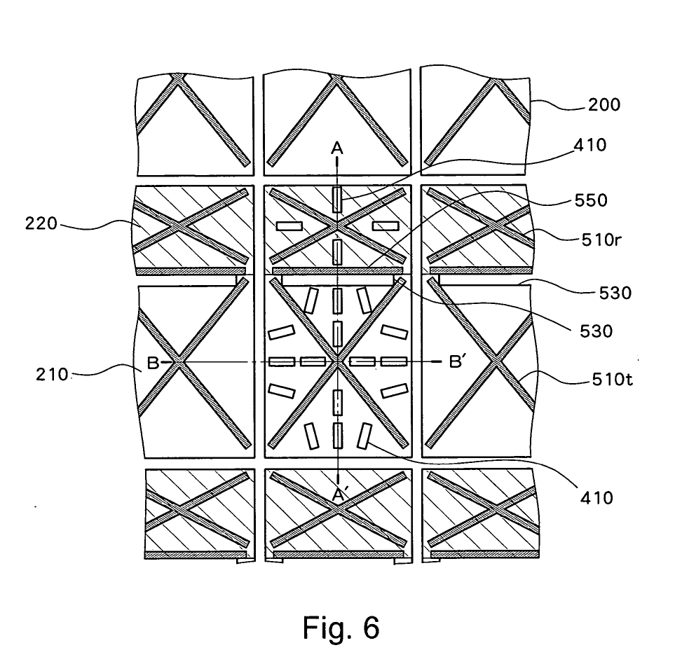

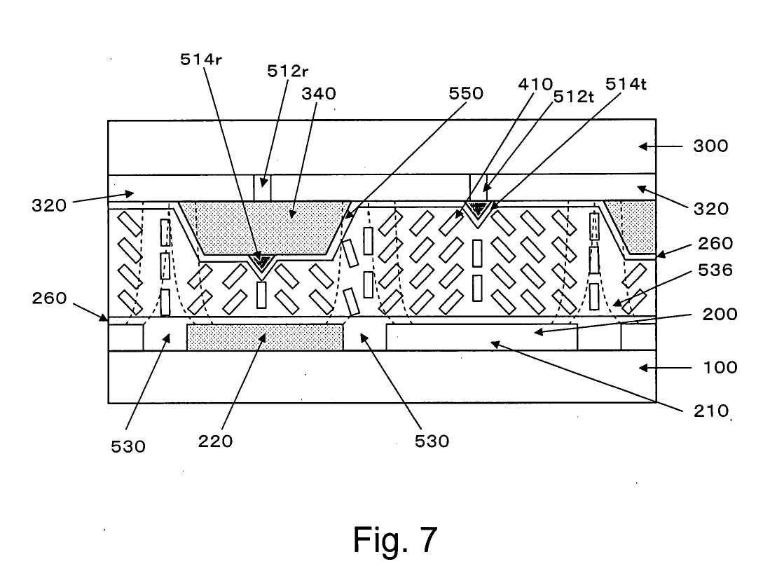

FIG. 6 is a schematic plan view showing the structure of a semi-transmissive type LCD including alignment controllers according to an embodiment of the present invention. FIG. 7 shows a schematic cross-sectional structural view taken along line A-A′ in FIG. 6. The schematic cross-sectional structural view taken along line B-B′ in FIG. 6 is identical to that shown in FIG. 3 or 5. The example LCD illustrated in FIG. 6 is of an active matrix type, in which each first electrode 200 is formed as a discrete pixel electrode and connected to a TFT not shown, while the second electrode 320 is formed as a common electrode. It should be noted that a semi-transmissive type LCD according to the present invention may alternatively be configured as a passive matrix type LCD.

In the example of FIG. 6, each pixel electrode 200 has a rectangular shape. Each formation region of a pixel electrode comprises a rectangular transmissive region 210 and a rectangular reflective region 220. Within each of the transmissive region 210 and the reflective region 220, an alignment controller 510 configured by forming an electrode absent portion 512 and a protrusion 514 in an overlapping arrangement as shown in FIG. 3 (or an alignment controller 520 as shown in FIG. 5) is provided in a substantially X-shaped pattern in the position corresponding to the diagonals of the rectangle. Accordingly, in FIG. 6, at least two X-shaped patterns of alignment controllers 510 are formed within one pixel region. With this arrangement, four alignment sections are created in each of the transmissive and reflective regions, such that a very wide viewing angle can be attained in both the reflective and transmissive modes. Further, such can be attained without impairing the transmittance and reflectance ratios and while avoiding degradation in contrast, because the width of the alignment controllers 510 can be minimized and the height of the protrusions 514 can be reduced according to the present invention.

In the semi-transmissive type LCD, as shown in FIG. 7, a transparent, insulative gap adjustor 340 composed of an acrylic resin or the like is provided for adjusting the optical length in each of the transmissive region 210 and the reflective region 220 to an optimum value in order to attain an optimum transmittance or reflectance ratio. In the present example, the gap adjustor 340 is formed within the reflective region 220, between the second substrate 300 and the liquid crystal layer 400. This gap adjustor 340 is designed considering particularly the anisotropy Δn of refractive index of the liquid crystal layer 400 and the thickness (cell gap) d of the liquid crystal layer 400, such that the cell gap dr within the reflective region 220 through which external light passes at least twice is adjusted to a desired value (or at least to a value smaller than the cell gap dt in the transmissive region 210). In the example of FIG. 7, the gap adjustor layer 340 is formed on top of the common electrode 320. More specifically, a slit-shaped electrode absent portion (window) 512r constituting a part of the alignment controller 510r is formed in the common electrode 320 within the reflective region 220. The above-described gap adjuster 340 is then formed covering the electrode absent portion 512r and the common electrode 320 in the region which is to become the reflective region. A protrusion 514r which protrudes toward the liquid crystal layer is subsequently formed on top of the gap adjuster 340 in a location overlapping the electrode absent portion 512r.

In the example of FIG. 7, no gap adjustor is provided in the transmissive region 210. In this region, a protrusion 514t is formed covering a slit-shaped electrode absent portion 512t formed in the common electrode 320. Further, an alignment film 260 is provided over the entire surface covering the common electrode 320, gap adjustor 340, and the protrusions 514t, 514r. A gap adjuster 340 edge located within one pixel region is positioned at the boundary between the reflective region 220 and the transmissive region 210. The edge of the gap adjuster 340 includes at least a sloped surface. A slant surface of the alignment film 260 formed along this sloped surface controls alignment of the liquid crystal molecules similarly to the slant surface created along the protrusion 514, thereby functioning as a type of alignment controller 500.

Further, in the present semi-transmissive type LCD, an electrode absent portion 530 is provided as an alignment controller on the pixel electrode 200 side at the boundary between the reflective region 220 and the transmissive region 210, so as to control alignment by means of a tilt in a generated weak electric field. Accordingly, at the boundary area between the transmissive region 210 and the reflective region 220, initial alignment of the liquid crystal is controlled on the second electrode side by the slant surface 550 of the gap adjustor 340 along a perpendicular direction to the slant surface, and the liquid crystal alignment is further controlled on the first substrate side by the tilt of the weak electric field generated at the electrode absent portion 530 so as to be divided into different directions at that location. With this arrangement, alignment division of the liquid crystal can be reliably effected at the boundary area between the transmissive region 210 and the reflective region 220. It should be noted that, similarly to on the second substrate side, the alignment controller on the first substrate side may be configured by additionally forming a protrusion in an overlapping arrangement with the electrode absent portion 530. By allowing the liquid crystal to align with respect to a slant surface of the alignment film 260 shaped by the additional protrusion, the alignment dividing ability can be increased. By providing the protrusion, the width of the electrode absent portion 530 can be further reduced, which would be advantageous in enhancing the transmittance or reflectance ratio.

In FIG. 7, an alignment controller formed with an electrode absent portion 530 is further provided at a gap between two adjacent pixel electrodes 200. This alignment controller may also be configured by further providing a protrusion overlapping the gap, which would be advantageous in realizing higher definition in an LCD.

Although not shown in FIG. 7, in order to perform color indication, color filters may be provided on the second substrate side (for example, between the common electrode 320 and the substrate 300). When voltage transmittance characteristics greatly differ among the wavelengths of R, G, and B, wavelength dependency of the LCD can be alleviated by changing the thicknesses of the gap adjustor 340 and the color filter for each of R, G, and B so as to adjust the thickness d of the liquid crystal layer for the respective colors.

While the gap adjustor 340 is formed on top of the common electrode 320 in the example of FIG. 7, it is alternatively possible to form the gap adjustor 340 on the second substrate 300 and then form the common electrode 320 over the entire substrate surface. An electrode absent portion 512 (512r, 512t) may also be created.

The protrusion 514 (or 524) which is formed overlapping the electrode absent portion 512 (522) for constituting the alignment controller 510 (520) according to the above-described embodiments may be composed of a transparent material or, on the contrary, a light-shielding material (such as a black filter material) for preventing undesired light passage. In either case, the material must be insulative. Further, the protrusion must protrude toward the liquid crystal layer 400 and include a slant surface having a tapered shape for aligning the liquid crystal. The tapered shape may be formed by the following method. For example, a positive resist material is employed as the material of the protrusion, and exposure is performed using a mask arranged to shield the region of the protrusion to be formed. During the exposure, the exposure light is diffracted to form the tapered shape.

Next described referring to FIG. 8 are a structure and fabrication method of the first electrode 200 (serving as the pixel electrode) and a TFT connected thereto which are applicable to an active matrix type LCD, and in particular, to a semi-transmissive type LCD as shown in FIG. 6. It should be noted that a transmissive type LCD can be obtained by using only transparent electrode materials as the pixel electrode (first electrode 200), and a reflective type LCD can be obtained by using a reflective material such as Al as the pixel electrode (first electrode 200).

In the example of FIG. 8, the TFT is of a top gate type. The active layer 20 is composed of polysilicon (p-Si) obtained by polycrystallizing amorphous silicon (a-Si) by laser annealing. The type of TFT is not limited to top gate type and may alternatively be bottom gate type. Further, the active layer 20 may be composed of a-Si. The impurities used to dope the source and drain regions 20s, 20d of the active layer 20 of the TFT may be either of n conductive type or p conductive type. In the present embodiment, impurities of n conductive type such as phosphorus are employed to form an n-channel type TFT.

The active layer 20 of the TFT is covered by a gate insulation film 30. On top of the gate insulation film 30, a gate electrode 32 composed of a refractory metal material such as Cr and Mo is formed. The gate electrode 32 also serves as a gate line. Subsequently, the active layer 20 is doped with the above-described impurities while using the gate electrode 32 as the mask, so as to form the source and drain regions 20s, 20d as well as the channel region 20c which remains undoped. An interlayer insulation film 34 is next deposited covering the entire TFT 110. After creating contact holes in the interlayer insulation film 34, an electrode material is arranged so as to form, through the contact holes, a source electrode 40 connected to the source region 20s of the p-Si active layer 20 and a drain electrode 36 connected to the drain region 20d. In the present embodiment, the drain electrode 36 also serves as a data line which supplies to each TFT 110 a data signal in accordance with a content of indication. The source electrode 40 is, as described later, connected to the first electrode 50 which serves as the pixel electrode. Both the source electrode 40 and the drain electrode 36 are composed of a highly conductive material such as Al.

After forming the source electrode 40 and the drain electrode 36, a planarizing insulation film 38 made of a resin material such as acrylic resin is formed over the entire substrate surface. Subsequently, a contact hole is created in the planarizing insulation film 38 at a position above the source electrode 40. A connection metal layer 42 is formed through this contact hole to connect the source electrode 40 and the metal layer 42. When the source electrode 40 is composed of Al, a metal material such as Mo is preferably used for the metal layer 42 in order to achieve a favorable ohmic contact between the source electrode 40 and the metal layer 42. Alternatively, the TFT may be configured without forming the source electrode 40. In such a case, the metal layer 42 is arranged to contact the silicon active layer 20 of the TFT 110. The metal layer material such as Mo can establish an ohmic contact with the semiconductor material constituting the active layer.

After lamination and patterning of the connection metal layer 42, a reflective material layer made of Al—Nd alloy, Al, or the like having a favorable reflective characteristic is formed on the entire substrate surface by a method such as vapor deposition or sputtering. In order to avoid obstructing the contact between the metal layer 42 and a pixel electrode 200 to be formed after the formation step of the reflective material layer, the laminated reflective material layer is etched to be removed from a region around the source of the TFT (where the metal layer 42 is formed). At the same time, the laminated reflective material layer is etched to be removed so as to avoid remaining in the transmissive region 210 in each pixel. As a result, the reflective material layer 42 is formed within the reflective region 220 of each pixel in a rectangular shape as shown in FIG. 6. In the present embodiment, in order to prevent irradiation of light on the TFT (especially on the channel region 20c) which may result in generation of a leakage current, and in order to maximize the reflectable area (namely, the display region), the reflective layer 44 is positively provided in the region above the channel of the TFT 110 as shown in FIG. 8.

In light of the patterning of the reflective layer 44, the metal layer 42 made of Mo or the like is designed to have a sufficient thickness (such as 0.2 μm) and sufficient resistance with respect to the etchant. Accordingly, after the reflective layer 44 disposed on top of the metal layer 42 is removed by etching, the metal layer 42 remains within the contact hole without being completely removed. Further, because the source electrode 40 is often composed of a material (such as Al) identical to the material of the reflective layer 44, if the metal layer 42 is not provided, the source electrode 40 would become corroded by the etchant, possibly resulting in a disconnection or the like. By providing the metal layer 42 as in the present embodiment, the TFT can be configured to have sufficient resistance with respect to the patterning of the reflective layer 44, and a favorable electrical connection with the source electrode 40 can be maintained.

After patterning the reflective layer 44, a transparent conductive layer is laminated over the entire substrate surface including the reflective layer 44 by sputtering. When performing the sputtering, the surface of the reflective layer 44, which is composed of Al as described above, becomes covered by a natural insulative oxide film. In contrast, a surface of a refractory metal such as Mo remains without being oxidized when exposed to a sputtering atmosphere. Accordingly, the metal layer 42 exposed at the contact region (for contacting with the source) establishes an ohmic contact with the transparent conductive layer which is subsequently shaped into pixel electrodes. After being laminated, the transparent conductive layer is patterned into rectangular shapes as shown in FIG. 6, for example, so as to form pixel electrodes 200. A pixel electrode 200 is independently shaped for each pixel but provided as one entity within one pixel to define both the reflective region and the transmissive region. After the pixel electrode 200 is patterned, an alignment film 260 composed of a material such as polyimide is formed covering the entire substrate surface, and fabrication of the structures on the first substrate side is thereby completed. The second substrate 300 may be prepared by providing R, G, and B color filters, a common electrode 320 and its electrode absent portions 512 (512r, 512t), gap adjustors 340, and protrusions 514 (514r, 514t), and subsequently covering these components with an alignment film 260. The first substrate 100 and the second substrate 300 prepared as described above are adhered to one another at the peripheral portions while maintaining a uniform gap between the two substrates. Liquid crystal is then sealed between the substrates to form an LCD.

1. A liquid crystal display device configured by providing a first substrate including a first electrode and a second substrate including a second electrode in an opposed arrangement with respect to one another, and interposing a liquid crystal layer between those substrates, the liquid crystal display device wherein each pixel region includes an alignment controller for dividing liquid crystal alignment within one pixel region into a plurality of sections having different alignment directions; and
the alignment controller includes at least a region in which an electrode absent portion and a protrusion including a slant surface protruding toward the liquid crystal layer are formed at the same location in an overlapping manner on at least one of a first substrate side or a second substrate side.

2. A liquid crystal display device as defined in claim 1, wherein
initial alignment of the liquid crystal layer is along a direction perpendicular to a planar direction of the substrates.

3. A liquid crystal display device as defined in claim 1, wherein
the first electrode provided on the first substrate side is formed in multiple numbers in individual patterns for the respective pixels;
a switch element is connected to each of a plurality of first electrodes;
the second electrode provided on the second substrate side is formed as a common electrode which serves commonly for the respective pixels; and
the alignment controller is formed within a forming region of the pixel electrode or within one pixel region of the common electrode.

4. A liquid crystal display device as defined in claim 1, wherein
the first electrode provided on the first substrate side is formed in multiple numbers in individual patterns for the respective pixels, while a switch element is connected to each of a plurality of first electrodes;
the second electrode provided on the second substrate side is formed as a common electrode which serves commonly for the respective pixels;
the pixel electrodes are arranged on the first substrate side in a matrix pattern; and
the alignment controller configured by forming the electrode absent portion and the protrusion in an overlapping arrangement is further provided between two adjacent pixel electrodes.

5. A liquid crystal display device as defined in claim 4, wherein
a reflective layer for reflecting light incident from a viewing side is provided on one of the first or the second substrate side which is arranged opposite the substrate on the viewing side.

6. A liquid crystal display device as defined in claim 4, wherein
the first and the second electrodes are transparent electrodes; and
indication is performed by transmitting light from a light source which is provided on a rear side of one of the first or the second substrate arranged away from a viewing side.

7. A liquid crystal display device as defined in claim 4, wherein
a reflective region in which external light is reflected and a transmissive region in which a light from a light source is transmitted are provided within said one pixel region.

8. A liquid crystal display device as defined in claim 1, wherein
the first electrode provided on the first substrate side is formed in multiple numbers in individual patterns for the respective pixels, while a switch element is connected to each of a plurality of first electrodes;
the second electrode provided on the second substrate side is formed as a common electrode which serves commonly for the respective pixels;
the pixel electrodes are arranged on the first substrate side in a matrix pattern; and
an alignment controller formed using the electrode absent portion alone is further provided between two adjacent pixel electrodes.

9. A liquid crystal display device as defined in claim 8, wherein a reflective layer for reflecting light incident from a viewing side is provided on one of the first or the second substrate side which is arranged opposite the substrate on the viewing side.

10. A liquid crystal display device as defined in claim 8, wherein
the first and the second electrodes are transparent electrodes; and
indication is performed by transmitting light from a light source which is provided on a rear side of one of the first or the second substrate arranged away from a viewing side.

11. A liquid crystal display device as defined in claim 8, wherein
a reflective region in which external light is reflected and a transmissive region in which a light from a light source is transmitted are provided within said one pixel region.

12. A liquid crystal display device as defined in claim 1, wherein
a reflective layer for reflecting light incident from a viewing side is provided on one of the first or the second substrate side which is arranged opposite the substrate on the viewing side.

13. A liquid crystal display device as defined in claim 1, wherein
the first and the second electrodes are transparent electrodes; and
indication is performed by transmitting light from a light source which is provided on a rear side of one of the first or the second substrate arranged away from a viewing side.

14. A liquid crystal display device as defined in claim 1, wherein
a reflective region in which external light is reflected and a transmissive region in which a light from a light source is transmitted are provided within said one pixel region.

15. A liquid crystal display device configured by providing a first substrate including a first electrode and a second substrate including a second electrode in an opposed arrangement with respect to one another, and interposing a liquid crystal layer between those substrates, the liquid crystal display device wherein
each pixel region includes an alignment controller for dividing liquid crystal alignment within one pixel region into a plurality of sections having different alignment directions;
the alignment controller at least includes a region in which an electrode absent portion and a protrusion including a slant surface protruding toward the liquid crystal layer are formed at a same location in an overlapping manner on at least one of the first substrate side or the second substrate side; and
within said one pixel region, an alignment controller formed using one or both of the electrode absent portion and the protrusion is further provided on a same or different substrate as the first or the second substrate on which said overlapped structure composed of the electrode absent portion and the protrusion is formed.

16. A liquid crystal display device as defined in claim 15, wherein
initial alignment of the liquid crystal layer is along a direction perpendicular to a planar direction of the substrates.

17. A liquid crystal display device as defined in claim 15, wherein
the first electrode provided on the first substrate side is formed in multiple numbers in individual patterns for the respective pixels;
a switch element is connected to each of the plurality of first electrodes;
the second electrode provided on the second substrate side is formed as a common electrode which serves commonly for the respective pixels; and
the alignment controller is formed within a forming region of the pixel electrode or within one pixel region of the common electrode.

18. A liquid crystal display device as defined in claim 15, wherein
the first electrode provided on the first substrate side is formed in multiple numbers in individual patterns for the response pixels, while a switch element is connected to each of a plurality of first electrodes;
the second electrode provided on the second substrate side is formed as a common electrode which serves commonly for the respective pixels;
the pixel electrodes are arranged on the first substrate side in a matrix pattern; and
the alignment controller configured by forming the electrode absent portion and the protrusion in an overlapping arrangement is further provided between two adjacent pixel electrodes.

19. A liquid crystal display device as defined in claim 15, wherein
the first electrode provided on the first substrate side is formed in multiple numbers in individual patterns for the respective pixels, while a switch element is connected to each of the plurality of first electrodes;
the second electrode provided on the second substrate side is formed as a common electrode which serves commonly for the respective pixels;
the pixel electrodes are arranged on the first substrate side in a matrix pattern; and
an alignment controller formed using the electrode absent portion alone is further provided between two adjacent pixel electrodes.

20. A liquid crystal display device as defined in claim 15, wherein
a reflective layer for reflecting light incident from a viewing side is provided on one of the first or the second substrate side which is arranged opposite the substrate on the viewing side.

21. A liquid crystal display device as defined in claim 15, wherein
the first and the second electrodes are transparent electrodes; and
indication is performed by transmitting light from a light source which is provided on a rear side of one of the first or the second substrate arranged away from a viewing side.

22. A liquid crystal display device as defined in claim 15, wherein
a reflective region in which external light is reflected and a transmissive region in which a light from a light source is transmitted are provided within said one pixel region.
